(19) United States
(12) Patent Application Publication
(10) Pub. No.: US 2024/0282212 A1
(43) Pub. Date: Aug. 22, 2024

(54) Educational and Developmental Method and System

(71) Applicant: Gartel LLC, Albuquerque, NM (US)

(72) Inventor: Swati Patel, Albuquerque, NM (US)

(73) Assignee: Gartel LLC, Albuquerque, NM (US)

(21) Appl. No.: 18/582,434

(22) Filed: Feb. 20, 2024

Related U.S. Application Data
(60) Provisional application No. 63/446,693, filed on Feb. 17, 2023.

(51) Int. Cl. G09B 7/04

(52) U.S. Cl. CPC G09B 7/04

(57) ABSTRACT

A method and computer software for recording educational development of a student. The method can include demonstrating a plurality of concepts to a student, allowing the student to choose to practice any one or more of the plurality of concepts while an instructor observes the student and records the number of times the student choses to practice each concept. When the student has not acquired the concept within a predetermined number of practice attempts, the instructor can demonstrate the concept to the student again—optionally by demonstrating the concept in a different manner. The method can include a student who appears to have acquired a concept teaching the concept to a student who has not acquired the concept. When the student is teaching the concept, the student can again be observed and reevaluated to see if the student truly has acquired the concept. The method can also include identifying subjects of interest to a student and can include further challenging a student who has an interest in a subject with one or more additional educational concepts in that subject.

### CROSS-REFERENCE TO RELATED APPLICATIONS

This application claims priority to and the benefit of the filing of U.S. Provisional Patent Application No. 63/446,693, entitled “Educational and Developmental Method and System”, filed on Feb. 17, 2023, and the specification thereof is incorporated herein by reference.

### BACKGROUND

Embodiments of the present invention relate to a method and system for monitoring and facilitating educational and developmental progress of students, more particularly, to monitoring and facilitating educational and developmental progress of students by teachers, administrators and parents via an interactive computer program. Embodiments of the present invention are particularly useful for students learning under Montessori teaching methods but are not limited to Montessori methods.

Historically, monitoring and tracking the educational and developmental progress of students, particularly those studying under Montessori teaching methods, has been done on an ad hoc basis. Often, teachers work with students and periodically make notes of their progress. Currently, there are no known academic programs that track social, emotional, and physical (“SEP”) progress of students. Thus, parents are often unaware if their child is delayed, has dyslexia, or is on the spectrum and needs extra support.

Traditional schooling involves evaluating academic progress based on grades received on assignments, quizzes and tests. Those grades are what are typically reported periodically to parents. This strictly numerical approach leaves much to be desired as it does not adequately convey to the parents the underlying educational and developmental progress of their students.

In Montessori-based teaching methods, such traditional numerical grading is not used. Instead, students are given projects also known as “works” which constitute modules for learning. These modules are always hands-on. In addition, the works often combine different subject areas into one work or project. The teacher first demonstrates the module and then the students practice the modules. Students choose which modules they wish to practice, which helps to guide independent and lifelong learners. The students then continue practicing the modules until the student has acquired the concept that is being taught. Repetition is a vital part of a child's development, as posited by Dr. Maria Montessori through scientific observation.

Montessori materials, which are multi-sensory learning tools, teach children how to problem-solve and self-correct through repetition and practice. Repetition is important for the sensitive periods during which children learn with ease. Sustained repetitive activity fosters the development of concentration and self-discipline. Repetition of practical life activities promotes the development of coordination and body awareness. The presence of repetition with high levels of concentration is indicative of the child filling a developmental need. Thus, practitioners need accurate representations of day-to-day repetition. Knowing the frequency, contexts, and structure of repetition is particularly helpful for new Montessori guides, who have limited practical experience on which to base their understanding of repetition. Children are strengthened by repetition. The purpose, intent, and meaning of the repetition of activity are different with each plane of development and will be interpreted by the guides accordingly. Repetition informs differently in the first plane and second plane. In the first plane sensitive period, repetition is needed to develop concentration and confidence, while the second plane informs more about potential difficulties or the need for alternative presentations, or to show the acquisition of the skill.

The presence and frequency of repetition are indicative of appropriate development in every child. Repetition also allows the teachers to identify strength and challenge areas. For example, if a child acquires a concept with fewer repetition, this indicates a strength area. Conversely, if a child continues to struggle with a concept after many repetitions and a variety of lessons, this is a challenge area. This allows teachers to work with each child on a personalized basis, keeping them challenged in the areas of strength, while provide additional support and lessons in areas of struggle.

Evaluating a student's performance in a Montessori school can be challenging because the educational approach emphasizes individualized learning and self-directed exploration. In a Montessori school, the emphasis is on the student's overall development and progress, rather than their performance on specific assignments. This means that assessing a student's abilities and progress in a Montessori classroom requires a more holistic approach. A further complication in evaluating performance in a Montessori school is that the curriculum is often tailored to the individual student's needs and interests. This means that students may be working on different projects or assignments at any given time and may practice a project more or less times than others. In Montessori schools, one child is not compared or otherwise ranked with respect to another student. Instead, such schools focus on the individual child and guide them through their development in a manner that uniquely fits that child's needs. Additionally, the Montessori method encourages students to work at their own pace, which means that some students may progress faster or slower than others. This further complicates the process of determining grades and comparing student progress. Accordingly, this system does not lend itself to numerical record keeping or letter-grading as easily as traditional education does. This therefore makes it even more difficult for parents to properly track the progress of their child's educational and developmental skills.

There is therefore a present need for a method and system which enables teachers to adequately track the progress of such students and to share that progress with the parents in a timely fashion. And especially there is a need for a method and system which tracks the progress of students throughout their academic career, and which can thus be used by institutions of higher learning, or potential employers for assessing the student for acceptance or employment.

### BRIEF SUMMARY OF EMBODIMENTS OF THE PRESENT INVENTION

Embodiments of the present invention relate to a method for providing educational development of a student, which can include demonstrating a plurality of educational concepts to the student, allowing the student to choose to perform any one or more of the plurality of educational concepts, maintaining indicia of interaction of the student with respect to each of the plurality of educational concepts, the indicia of interaction including a first field that itself includes a first record representing a number of attempts by the student performing each respective one of the plurality of educational concepts and a second field comprising a second record of whether the student has acquired each respective one of the plurality of educational concepts, observing the student performing the chosen one or more of the plurality of educational concepts, evaluating whether the student has acquired at least one of the plurality of educational concepts, updating the first record of the first field for each respective educational concept to indicate the number of times the student was observed to perform the respective educational concept, comparing the first record of the first field to a predetermined value, and providing reinforcing education to the student for each of the plurality of educational concepts for which the first record of the respective first field meets or exceeds the predetermined value.

The predetermined number can be different for at least two of the plurality of educational concepts. The method can also include updating the second record of the second field to indicate competency when the results of the evaluation step result in a finding of competency. The method can also include presenting a new educational concept to the student after a finding of competency for at least one of the plurality of educational concepts. In one embodiment, maintaining indicia of interaction can include maintaining a database file. The predetermined value can include a whole number. Providing reinforcing education to the student can include demonstrating each of the plurality of educational concepts for which the first record of the respective first field meets or exceeds the predetermined value.

In one embodiment, the method can include a third field that includes a record representing results of observed social or emotional condition or observed social or emotional progress of the student, selected from the group consisting of: self-control, social maturity, cooperativeness, assuming responsibility for actions, self-confidence, acceptance of guidance, working well with others, dependability, self-motivation, adaptability, responding well to challenges, identifying feelings, and expresses feelings.

The method can also include a third field comprising a third record representing results of an observed physical condition or physical progress of the student, selected from the group consisting of lifts head, smiles, turning to face stimulus, sits up with support, sits up without support, laughing, crawling, pulling up to standing position, walks with support, walks without support, places objects into container, feeds self, walks backwards, kicks a ball, eats independently, throws an object, stacks objects, drinks from a cup, and scribbles. Optionally, the educational concepts can include physical educational concepts, academic educational concepts, and/or hands-on Montessori works. The processor can update the indicia of interaction of the student. Optionally, the processor can compare the first record of the first field to the predetermined value.

The method can include providing a parent portal. Optionally, educational progress of a parent's respective student can be displayed on a user interface. Information regarding educational concepts can be displayed on the user interface. Milestones and/or other information relating to the student or work or data prepared by the student, can be input into a profile of the student by the student and/or by a parent of the student. The profile of the student can also include information relating to educational developmental milestones which can be entered by an instructor. The profile of the student can be successively added to year after year throughout a period of years of a childhood of the student and the profile can include a selectable field associated with a plurality of items of information such that the student and/or the student's parent can select at least some of the items of information from the first record and/or the second record and wherein the selected items can be extracted and shared electronically with secondary schools and/or employers.

In one embodiment, the step of maintaining indicia of interaction of the student is performed by a first instructor of an organization and a second instructor of the organization, which can be a higher-level instructor than the first instructor, reviews at least some of the maintained indicia to determine an appropriate course of instruction for the student such that the second instructor begins working with the student at or near a level where the first instructor stopped. This avoids the second instructor unnecessarily repeating information that was already well learned by the student.

Optionally, evaluating whether the student has acquired at least one of the plurality of educational concepts can include recording indicia of acquisition of an acquired educational concept. The method can also include monitoring the student while the student teaches the acquired educational concept to a second student who has not acquired the educational concept. The method can also include reevaluating whether the student has acquired the acquired educational concept based on the results of the monitoring. The method can also include identifying a subject of interest to the student based at least in part on information contained in the first field and/or the second field. The method can also include challenging the student with one or more further educational concepts in the identified subject of interest.

In one embodiment, the first record, second record and/or third record, or any subset thereof, can optionally all be a single shared record, which can include a single dataset, data file, and/or data that is stored in a single file, which can optionally comprise a file containing first, second and/or third records from one or more other students.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1A and 1B are screenshots that respectively illustrate an attendance dashboard and an attendance record being updated;

FIG. 2 is a screenshot of a lesson planning portion of a user interface which displays lessons that are assigned to an individual student, the lesson planning module allows the teacher to plan ahead and develop a path that is unique to each child based on which concepts the child has acquired and which concepts the child is struggling with;

FIG. 3 is a screenshot of an individual student record being updated in a record keeping portion of an embodiment of the present invention;

FIG. 4 is a screenshot of an individual student record where only the acquired skills have been selected to be displayed;

FIG. 5 is a screenshot which illustrates the status of a student practicing a lesson being updated by a teacher;

FIG. 6 is a screenshot which illustrates a note field being presented to a teacher for re-presenting a lesson;

FIG. 7 is a screenshot which illustrates a lesson selection screen according to an embodiment of the present invention;

FIG. 8 is a screenshot of a lesson planning screen for an elementary math class for algebra;

FIG. 9 is a screenshot of a lesson description for an algebra lesson;

FIG. 10 is a screenshot which illustrates a user interface where a teacher can assign a lesson to one or more students, in one embodiment, the teacher dashboard is for the teacher's self-evaluation within the entire curriculum—the teacher dashboard allows the teacher to know immediately which areas of the curriculum he or she is spending time on and which ones he or she is neglecting; this immediate feedback provides teachers the ability to correct the course and ensure that they are addressing all areas of the curriculum with all children in the classroom;

FIG. 11 is a screenshot of a teacher dashboard showing an overview of a student report;

FIG. 12 is a screenshot of an individual student's academic summary on a teacher's dashboard, according to an embodiment of the present invention;

FIG. 13 is a screenshot of a dashboard for a class of students with a graphical indicator to show the status/progress of the class;

FIG. 14 is a screenshot of a messaging interface;

FIG. 15 is a screenshot of a notifications interface;

FIG. 16 is a screenshot of an accident notification user interface;

FIG. 17 is a screenshot of an academic notification user interface;

FIG. 18 is a screenshot of annotation interface for adding a note to an SEP profile for a student;

FIG. 19 is a screenshot of a class selection portion of an SEP assessment interface;

FIG. 20 is a screenshot wherein a teacher is updating an SEP assessment of a student;

FIG. 21 is a screenshot showing an SEP summary for a student;

FIG. 22 is a screenshot showing a lessons overview for a class according to an embodiment of the present invention; and

FIG. 23 is a drawing which illustrates a method for providing educational development to a student according to an embodiment of the present invention.

### DETAILED DESCRIPTION OF THE INVENTION

Embodiments of the present invention are directed to methods and systems employing processes that store, apply algorithms to transform, and to display data for purposes of several distinct functions or modules as will be described herein: an “SEP” module, a record keeping module and a lesson planning module, and the ability for all this data to follow the student throughout their educational career and between educational entities. In one embodiment, the data is also shared from teacher to teacher so that a new teacher can know exactly where the child is academically, socially, emotionally, and physically. This ensures that the teacher is not wasting the child's time by conducting assessments which can take up to four weeks to complete. The child in turn continues his or her development in all areas without any interruptions. Each of these modules are described separately below.

### Social, Emotional, and Physical (“SEP”)

In one embodiment, the present invention preferably provides the ability to monitor, evaluate and record the social, emotional, and physical development of the student. Traditional schools only monitor academic progress of children. In order to serve the whole child, social, emotional, and physical development should also be monitored to ensure that the child is developing into a happy, healthy child who embodies a love for learning. These features enable a teacher and/or parent the ability to not only monitor their students' developmental progress but also the ability to identify possible developmental disorders early on when intervention can have the greatest impact. As previously noted, in Montessori schools, lessons are referred to as “works.” Thus, throughout this application, the terms “work(s)” and or “lesson(s)” are used interchangeably and are intended to cover both “work(s)” and or “lesson(s)” when applied to the teachings of Montessori schools or non-Montessori schools. Still further as used throughout this application under the Montessori school principle, students are monitored to determine when they have acquired a lesson versus conventional education models which periodically grade a student. Thus, the term and/or concept of “acquiring” a work or lesson (as used in Montessori schools), is intended to be used interchangeably with a periodic grading or evaluation of the student on a lesson (as is done in conventional schools).

For example, in an infant, the present invention enables users to identify the date on which the infant achieved each of the following social and emotional milestones for the first time:

### Birth-Six Weeks

Turns towards familiar voices
Prefers faces of immediate family over others
Calms with skin-to-skin contact

### 2-4 Months

Smiles
Shows excitement
Calms self with sucking
Begins social smiling

### 4-8 Months

Giggles
Actively seeks human interaction
Shows various emotions (Delight, anger frustration, silly, sadness)
Responds to name
“talks” with caregiver (smiles and coos)
Exhibits intentionality in behavior
Notices strangers and reacts with either stranger danger or curiosity
Copies simple actions of others

### 8-12 Months

Imitates behaviors
Attaches to objects (blanket or favorite toy)
Increasing fearfulness of strangers
Separation anxiety
Parallel play
Begins to show interest in other children
Starts to communicate wants with actions other than crying
Recognizes self in mirror

### 12-18 Months

Expresses affection for others
Shows pride in achievements
Strong interest in playing with other children
Seeks attention with silliness
Starts to show self will
Starts using language to communicate
Exchanges objects with someone
Enjoys doing things by self
Begins to understand compromise
Shows possessiveness
Helps others
Begins to cooperate
Very assertive

Embodiments of the present invention can also provide the ability for a teacher and or parents to identify the date on which the infant achieved each of the following physical milestones (this allows for early detection of any developmental delays and help can be provided to the child during the most crucial phase of his or her growth):

### 1-3 Months

Supports head and upper body when on stomach
Opens and shuts hands
Lifts head
Swipes and bats at dangling objects
Follows moving objects with eyes
Turning their head to face the stimulus
Makes cooing sounds
Smiles
Smiles at familiar faces

### 4-7 Months

Rolls over both ways (stomach to back, back to stomach)
Sits up with, and then without, support of his hands
Transfers objects from hand to hand
Supports whole weight when on legs and held upright
Explores objects with hands and mouth
Explores objects by banging and shaking
Laughs
Babbles
Teething

### 8-12 Months

Gets in and out of a sitting position independently
Sits without support
Gets on hands-and-knees position and crawls
Pulls self up to standing position, walks holding on to furniture, stands without support and, eventually, takes a few steps without support and begins to walk
Uses pincer grasp (thumb and first finger)
Places objects into container and takes them out of container
Begins to do more functional activities, such as hold a spoon or turn pages in a book
Says “mama” and “dada” and uses these terms specifically referring to a parent
Uses exclamations such as “oh-oh!”
Uses simple gestures, such as shaking head for “no” or waving for “bye-bye”
Plays interactive gesture games, such as pat-a-cake and peek-a-boo
Uses objects correctly such as holding phone up to ear or drinking from a cup
Turns knobs
Starts feeding self—finger foods
Recognizes familiar objects in pictures

### 13-18 Months

Walks independently
Walks backwards
Walks up stairs
Kicks a ball
Eats independently
Throws a ball
Turns pages in a book
Stacks two blocks
Points at some objects when named
Follow simple instructions such as “Pick up your toy”
Drinks from a cup
Wants to help with household activities
Plays simple pretend, such as feeding a doll
Points to body parts
Can help undress herself
Scribbles
Has 1-10 words
Will sit for 2-5 minutes

Likewise, for a toddler, embodiments of the present invention preferably provide the ability for a parent and or teacher to identify the date on which the toddler achieved each of the following SEP milestones:

| | |
|---|---|
| Cognitive | 18-24 Months |
| Development | Can choose between two options |
| | Concentrates 1-5 minutes |
| | Uses trial and error to impulsively problem solve |
| | Problem solves to get an object |
| | Follows instructions without gestures |
| | Shows spatial awareness |
| | Follows two step direction |
| | Knows where things belong |
| | Matches objects |
| | Pursues an activity after being distracted |
| | 24-36 Months |
| | Concentrates 6-10 Minutes |
| | Uses objects symbolically |
| | Describes picture |
| | Tells about a past event |
| | Describes what he/she is doing |
| | Names three colors |
| | Verbally asks for specific objects |
| | Makes something with play dough/clay |
| | Can complete simple puzzle |
| | Demonstrates knowledge of opposites |
| | Follows three step direction |
| Gross Motor | 18-36 Months |
| | Can walk up steps |
| | Walks well |
| | Heel to toe |
| | Can kick a ball |
| | Can climb |
| | Can throw a ball |
| | Can march |
| | Runs well |
| | Can jump |
| | Hops on two feet |
| | Walks backwards |
| | Can catch a ball |
| | Tries to walk tip toe |
| | Hops on one foot |
| Fine Motor | 18-36 Months |
| | Strings large beads together |
| | Pours from pitcher into cup |
| | Scribbles |
| | Can put together a peg puzzle |
| | Using tongs for serving food |
| | 24-36 Months |
| | Can string small beads |
| | Turns knob to open door |
| | Can put on own shoes |
| | Can open and close lunch containers |
| | Holds pencil with fingers and thumb |
| Social and | 18-24 Months |
| Emotional | Takes pride in accomplishments |
| | Asks for help from others |
| | Engages in parallel play (Plays alongside other children with |
| | some exchange of toys) |
| | Helping others spontaneously |
| | Imitates another child or adult |
| | Greets visitors |
| | Looks to teachers for comfort |
| | Looks to peers for comfort |
| | Plays comfortably in a small group of children |
| | Selects work independent of adult |
| | Uses socially acceptable verbal and non-verbal approaches |
| | to join other children |
| | who are engaging in cooperative play |
| | Showing Empathy towards peers |
| | Is eager to participate in group activities |
| | Makes positive statements about self, such as “I did it,” “Look |
| | at me” |
| | 24-36 Months |
| | Engages in interactive play |
| | Concept of sharing begins to emerge (Negotiates with peer |
| | about toys, |
| | taking turns or trading) |
| | Works collaboratively toward a goal with peers, such as |
| | digging a hole in the |
| | sand or building a castle with blocks |
| | Begins to use words to solve conflict |
| | Follows the majority of classroom/playground rules |
| | Accepts and follows classroom directions |
| | Helps another child follow routine |
| | Engages in pretend play |
| | Engages in cooperative play |
| | Engages in talk at mealtime |
| | Demonstrates respectful attitude towards adults |
| | Refers to another child as his/her friend |
| | Demonstrates control while participating in group activities |
| | Watches and observes others working while demonstrating control of impulses |
| | to touch or join in |
| | Demonstrates respectful attitude towards peers |
| | Chooses to let another child go first at an activity |
| | Helping others with apparel |

For an elementary age student, embodiments of the present invention preferably provide the ability for a parent and or teacher to monitor and/or rate each of the following SEP aspects, which include soft skills that eventually lead to executive functioning and overall success of the child in adulthood. Such SEP ratings can include, for example, assigning a numerical value to each item and/or assigning a descriptive identifier, which itself can include, “never, sometimes, often, frequently, always”:

Elementary SEP

| | |
|---|---|
| Behavior/Work Habits | Listens and follows directions |
| | Works cooperatively in groups |
| | Works with care |
| | Takes responsibility for actions |
| | Completes work in a timely manner |
| | Communicates needs effectively |
| | Concerned with safety |
| | Treats others with respect |
| | Shows interest |
| | Puts effort into work |
| | Social Development |
| Grace and Courtesy | Shaking Hands |
| | Greeting & Introduction to a Friend/Visitor |
| | Uses Manners: Please, Thank-You, I'm Sorry, Yes Sir/Ma'am, Asking to |
| | be excused |
| | Patience/Waiting in Line/Standing in Line |
| | Proper Eating Etiquette |
| | Answering the Phone/Leaving a Message |
| | Use of Kleenex/Sneezing in Elbow |
| | Hand Washing |
| | Safely Transporting Sharp & Fragile Objects |
| | Proper Use of the Toilet |
| | Peer Observation Skills |
| | Demonstrates an Awareness of Classroom Routines & Rules |
| Inner Social/Emotional | Works Well with Adults |
| Discipline | Works Well with Peers |
| | Demonstrates an Understanding of Own & Others' Feelings |
| | Accepts Guidance & Direction |
| | Appropriate Impulse Control/Self-Control |
| | Demonstrates Self-Confidence |
| | Dependability |
| | Curbs Excessive Competitiveness on the Playground |
| | Displays Social Maturity |
| | Positive Feeling of Self |
| | Respectful of Self |
| | Respectful of Others |
| | Good Attitude Towards School |
| | Follows Class Guidelines |
| | Cooperative |
| | Assumes Responsibility for Actions |
| Character Education | Respect-Ways to be Respectful |
| | Peace Seeking-Being a Peace Seeker |
| | Responsibility-Ways to be Responsible |
| | Compassion-Ways to be Compassionate |
| | Generosity-Ways to Show Generosity |
| | Commitment-What is Commitment? |
| | Loyalty-How to be Loyal |
| | Love-How to Show Love |
| | Honesty-What is Honesty? |
| | Health-How to be Healthy |
| | Humor-How to be Humorous/What is Humor? |
| Self-Management | Manages Stress Well |
| | Exhibits Self-Discipline |
| | Is Self-Motivated |
| | Sets Goals and Works Towards Them |
| | Is Flexible and Adaptive |
| | Stays Calm When Criticized |
| | Responds Well to Challenges |
| | Takes Responsibilities for Mistakes and Fixes Them |
| | Manages Time Wisely |
| | Perseveres Through Obstacles |
| | Transitions Between Activities Smoothly |
| Self-Awareness | Demonstrates Self-Confidence |
| | Works Independently |
| | Communicates Needs Constructively |
| | Shows Eagerness to Learn |
| | Recognizes Strengths |
| | Recognizes Limitations |
| | Exhibits Emotional Maturity |
| Responsible Decision Making | Follows Directions |
| | Follows Classroom Rules |
| | Adapts to Daily Routines |
| | Resolves Conflicts Peacefully |
| | Exhibits Leadership Qualities |
| Relationship Skills | Understands the Importance of Cooperation |
| | Relates Well with Adults |
| | Relates Well with Other Children |
| | Listens to Others |
| | Asks for Help from Teacher(s) |
| | Offers to Help Others |
| | Works Well in Groups |
| | Interacts with All Age Groups |
| | Resists Negative Peer Pressure |
| Social Awareness | Works Without Disturbing Others |
| | Shows a Positive Attitude Towards School |
| | Exhibits Community Awareness |
| | Appreciates Different Cultures |
| | Shows Concern for Others |
| | Shows Care for the Environment |
| | Displays Social Maturity |

Optionally, the foregoing aspects can be evaluated and rated by the student and/or teacher on a periodic basis—for example yearly, quarterly or each semester.

For students beyond elementary school age, embodiments of the present invention preferably provide the ability for a teacher and or parent to monitor and or evaluate each of the following aspects:

Behavior/Work Habits

| | |
|---|---|
| Self-Management | Manages Stress Well |
| | Exhibits Self-Discipline |
| | Is Self-Motivated |
| | Sets Goals and Works Towards Them |
| | Is Flexible and Adaptive |
| | Stays Calm When Redirected |
| | Responds Well to Challenges |
| | Takes Responsibilities for Mistakes and Fixes Them |
| | Manages Time Wisely |
| | Perseveres Through Obstacles |
| | Transitions Between Activities Smoothly |
| | Three-part Work Cycle (Take work, work with it and put it away) |
| Self-Awareness | Can Identify and Express Feelings |
| | Demonstrates Self-Confidence |
| | Works Independently and remains focused on the task |
| | Communicates Needs Constructively |
| | Shows Eagerness to Learn |
| | Recognizes Strengths |
| | Recognizes Limitations |
| | Exhibits Emotional Maturity |
| | Responsible Decision Making |
| Follows Directions | Follows Classroom and Playground Rules |
| and Organizes Work | Adapts to Daily Routines |
| | Resolves Conflicts Peacefully |
| | Exhibits Leadership Qualities |
| | Relationship Skills |
| Understands the | Relates Well with Adults |
| Importance of | Relates Well with Other Children |
| Cooperation | Listens to Others |
| | Asks for Help from Teacher(s) |
| | Offers to Help Others |
| | Works Well in Groups |
| | Interacts with All Age Groups |
| | Resists Negative Peer Pressure |
| | Social Awareness |
| | Works Without |
| | Disturbing Others |
| | Shows a Positive Attitude Towards School |
| | Exhibits Community Awareness |
| | Appreciates Different Cultures |
| | Shows Concern for Others |
| | Displays Social Maturity |
| | Shows Care for the Environment |

Like with the elementary SEP evaluation criteria, the foregoing criteria can also be evaluated periodically and can be assigned a numeric and or descriptive value for each entry.

### Record Keeping

Embodiments of the present invention provide the ability for record keeping throughout the student's life or other evaluation period (i.e., school year, elementary school, school career). In one embodiment, parents can see the lesson that was provided to the student, how many times the student practiced the lesson and any notes that the teacher entered regarding the student. The parents can also observe the lesson description, and the title of the description can contain details describing what the lesson covers, the objectives, and how the teacher determines whether the student has acquired the skill that was desired to be taught in the lesson. An important aspect of Montessori curriculum is how often a child practices with the works before he or she acquires the concept. This provides data for teachers to further personalize the curriculum. For example, if a child is consistently acquiring concepts in math after only a few practices, that is their strength area. This allows the teacher to keep moving the child forward in Math. If a child is struggling with concepts in another area, that is an area of challenge for the student. By recognizing these areas of challenge, the teacher can recognize that he or she needs to focus more on that area (for example, by providing lessons multiple ways) until the child understands and has acquired the concepts. The parents can also see the date that it was presented and the date that the student acquired or was otherwise evaluated and/or graded on it.

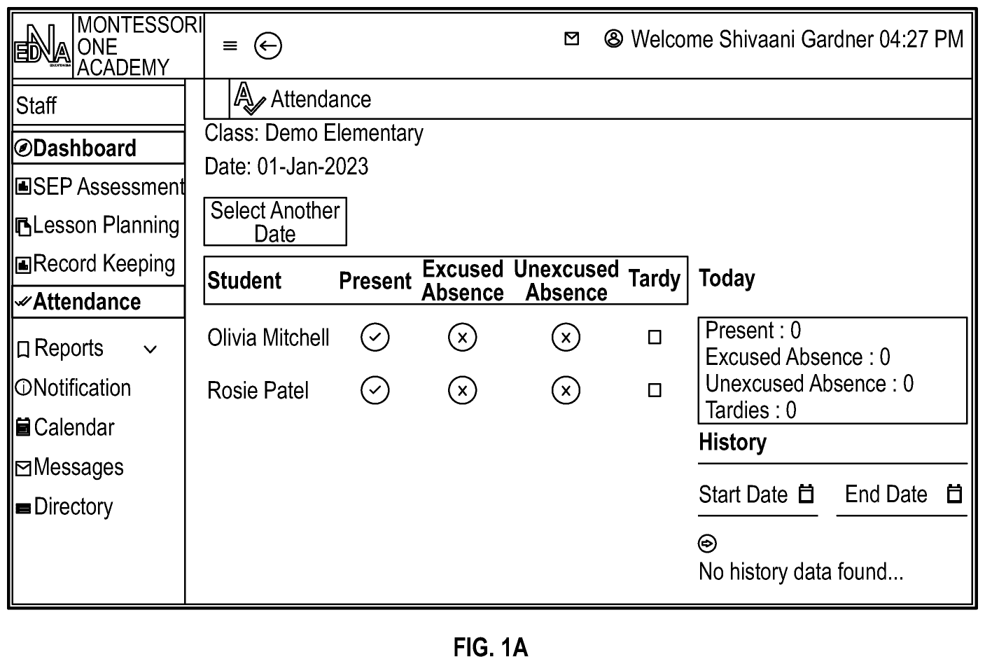

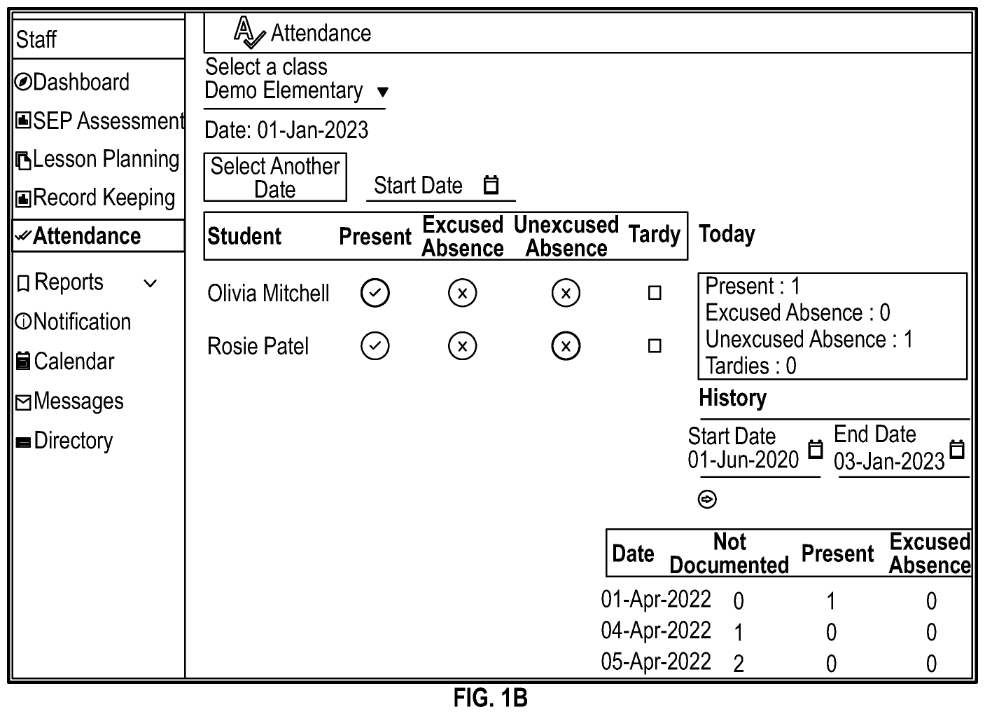

In the record keeping system of embodiments of the present invention, a teacher's portal is preferably provided. Within the teacher's portal, the teacher can plan lessons by picking which lesson to give to the students and inviting a student to perform the lesson (for example when the teacher believes that the student is ready to practice a work). The teacher can show the lesson to the student and then monitor and record how many times the student practices the lesson before acquiring the concept or otherwise being graded on it. Thus, in a Montessori school setting, students are free to go pick up a work that has already been demonstrated to them and practice it before putting it back and picking up a different work. In Montessori school, the teacher preferably observes the students and makes a note in the teacher's portal to indicate each time that a student has practiced a particular work, thus building a record of the number of times the teacher has demonstrated each work to each student and the number of times that each student has practiced that work and whether or not each respective student has acquired the concept and if so, the date that each student acquired the concept. In this user interface, the teacher can also preferably update the attendance record for each student (see FIGS. 1A and 1B).

As illustrated in FIGS. 1A and 1B, the teacher can open an attendance record for all students in a class (in the example of FIG. 1A, two students are illustrated). The teacher can quickly select which students are present and which are absent with an excused absence or an unexcused absence (FIG. 1B). This saves the teacher's time by eliminating the need to fill out and properly file/route paper documents. This allows the teacher to spend more time working with children instead of doing paperwork. The teacher can also mark which students are tardy in arriving to a class. A calendar can also be provided such that the teacher can select a date range, and an attendance summary for each student can be provided.

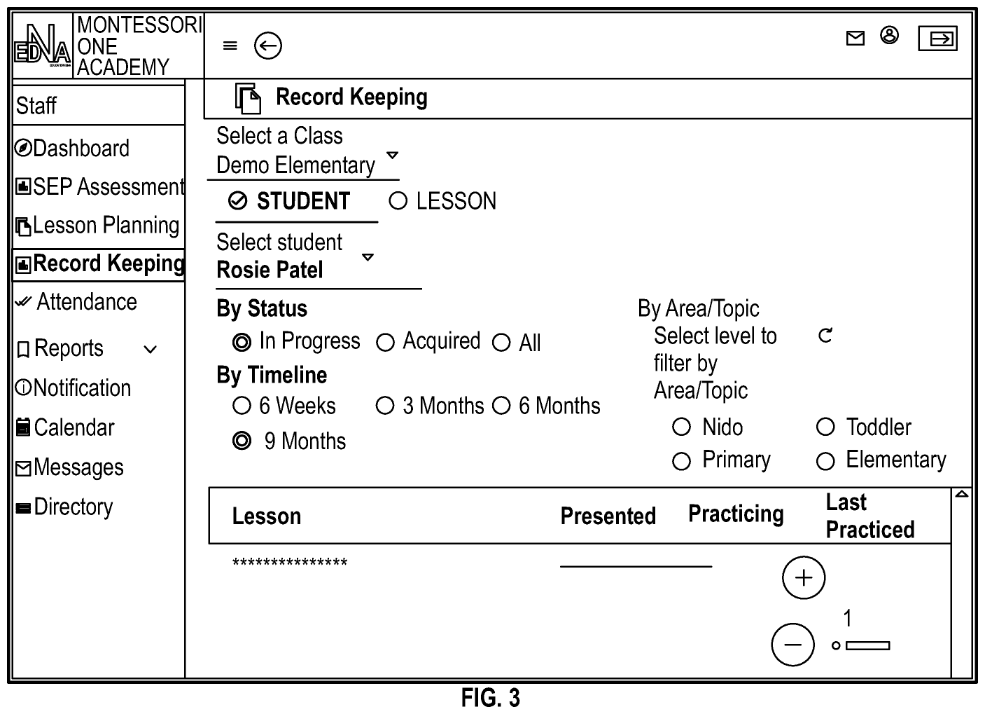

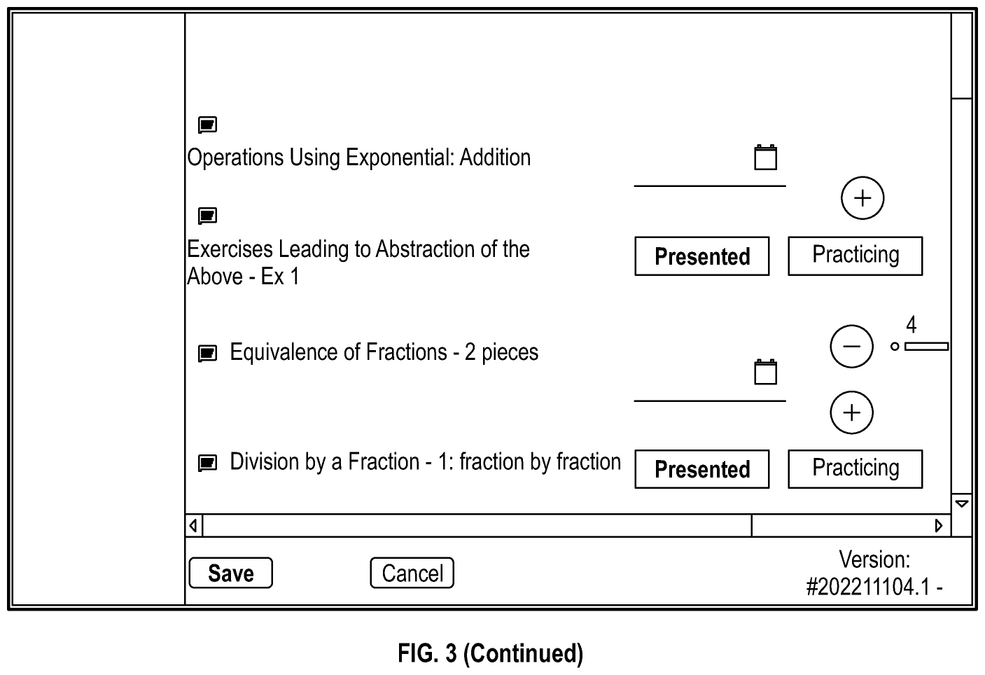

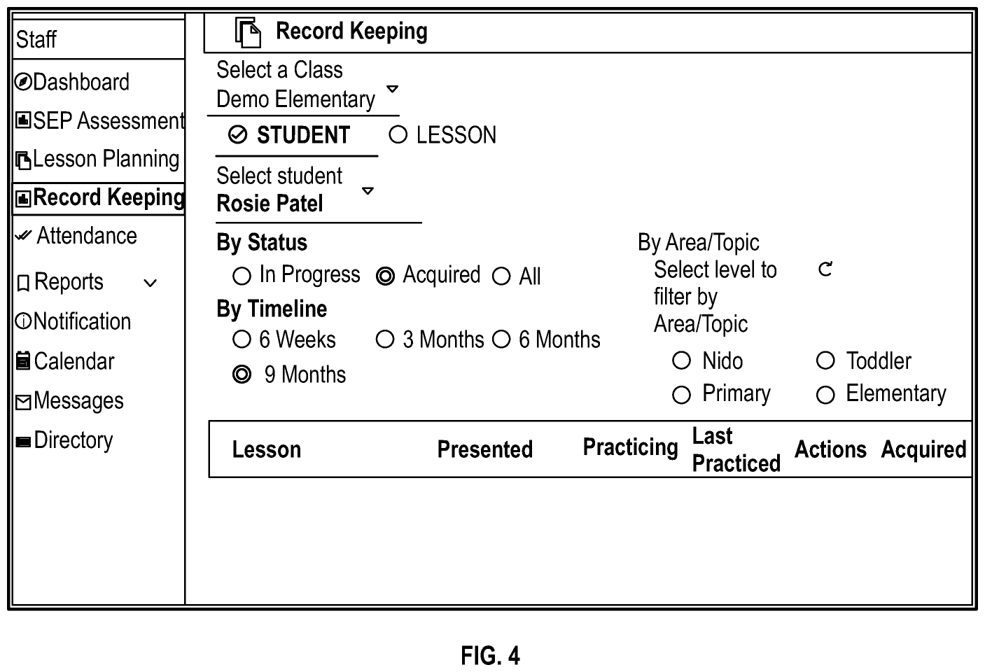

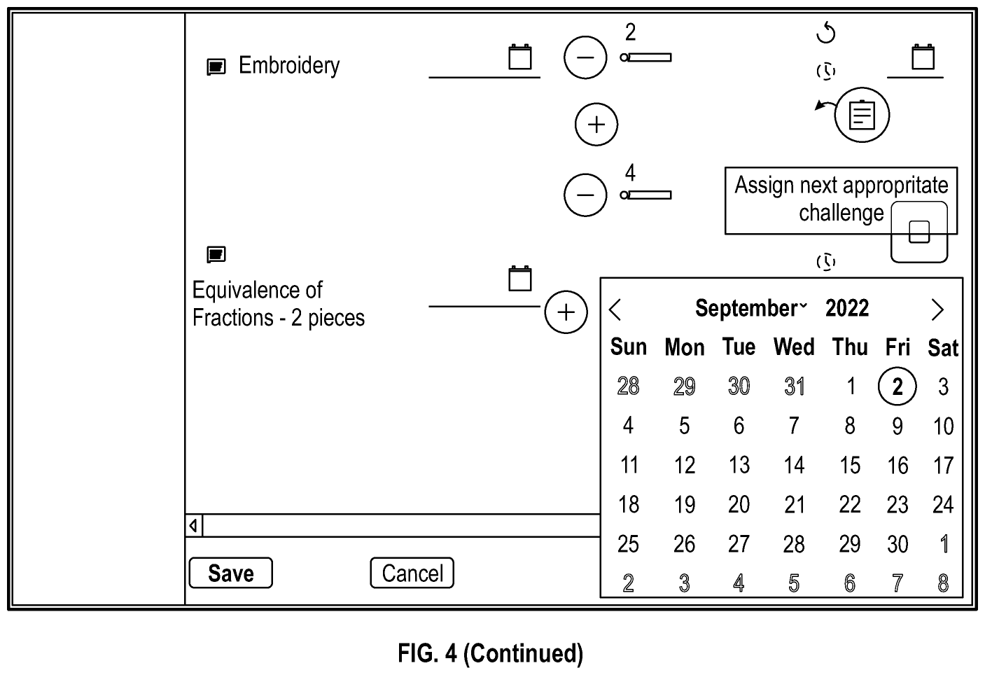

As best illustrated in FIGS. 3 and 4, in the record keeping interface, the teacher can also select a student to display and/or update their status and/or progress regarding one or more lessons. For example, in FIG. 3, student Rosie Patel is in progress (i.e., has not yet acquired the lessons) for operations using exponential notation, she has practiced the lesson once and has practiced the Equivalence of Fractions lesson 4 times.

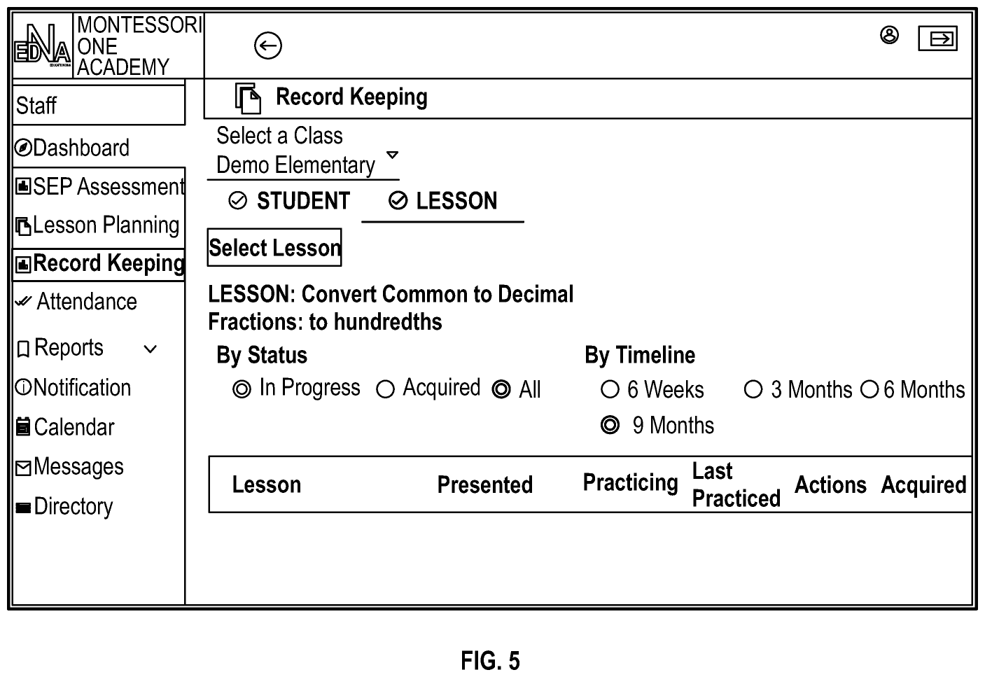

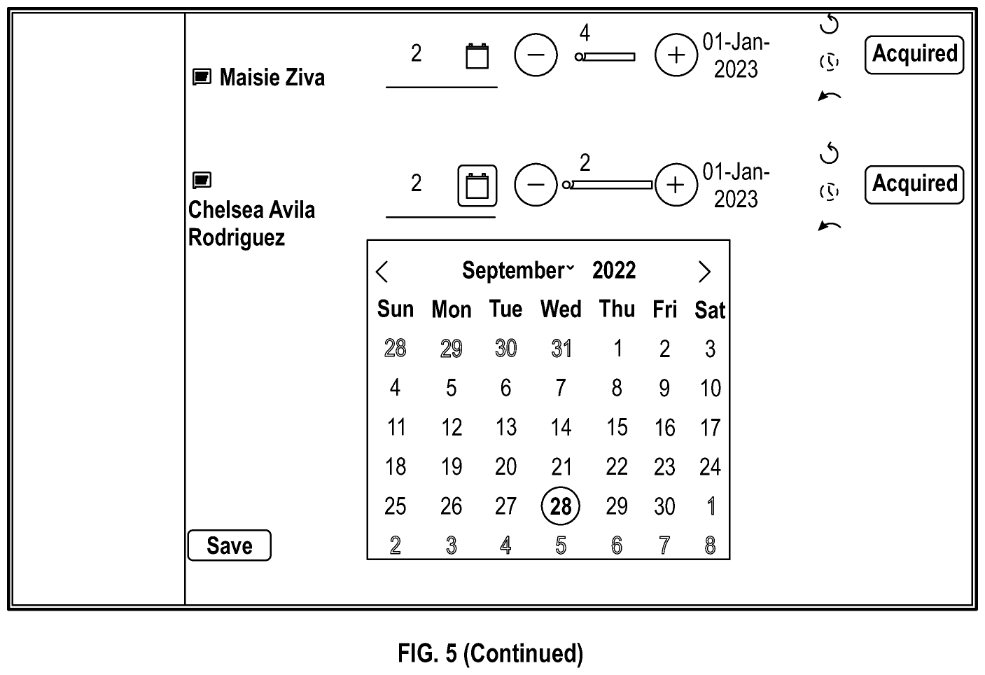

In FIG. 4, the teacher has selected the “acquired” option to display only those actions which the student has acquired. The instructor can also select an option to assign a next appropriate lesson or challenge. As illustrated in FIG. 5, the instructor can quickly and easily update the number of times that each student in a class has practiced a particular lesson and can optionally flag whether the student has acquired the lesson or not. The teacher can also be presented with a calendar so that the teacher can easily click on the date next to each student to indicate which days the teacher has presented the lesson to the student. The teacher then observes the students, who in a Montessori school environment, can decide which works they wish to engage with. The students then pick out their work and practice on it. Each time the student practices on it the teacher notes another practice session for that particular work in the record keeping software.

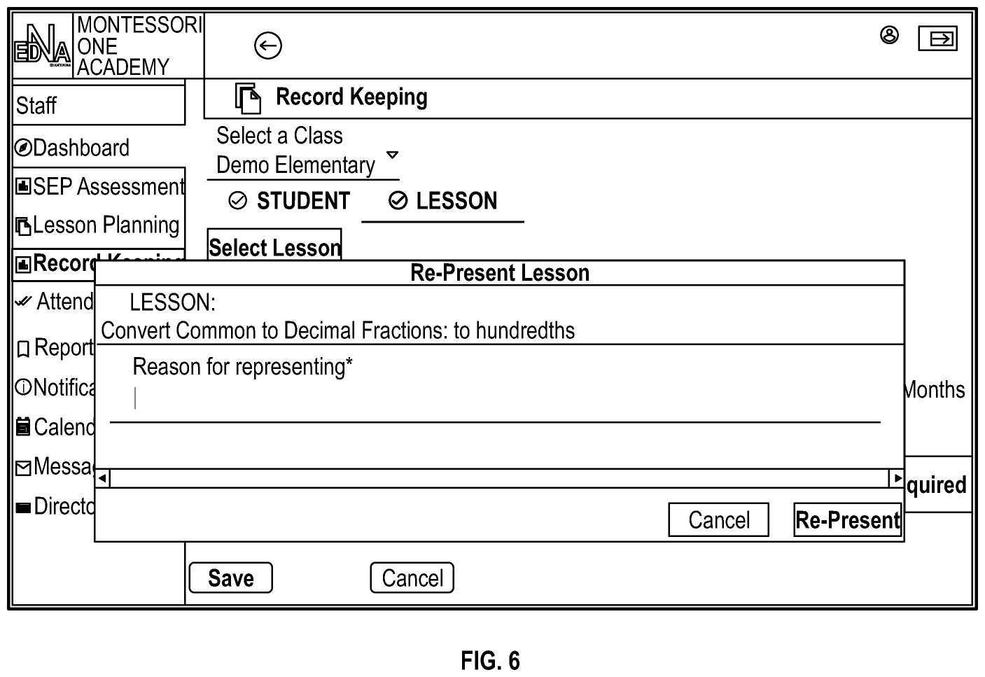

If a student has acquired the concept being taught which the teacher can determine based on watching the student and or asking the student questions about the work, the teacher can flag that the lesson has been acquired by the student in the record keeping interface. If the student has practiced a lesson more than a predetermined number of times and has not acquired the concept being taught, the system can automatically issue an alert to the teacher when the number of practice sessions has exceeded the predetermined number and the teacher can optionally then elect to re-present the lesson to the student (see FIG. 6), or the teacher may decide they need to demonstrate the work to the student using some other method or concept or by first introducing the student to some other work in order to better enable the student to grasp the concept and thus acquire the concept. This shows which areas the child is showing strength in and which areas need more attention. And, it provides the ability for the teacher to watch the student more closely to determine whether or not the student is merely continuing to practice a work because they enjoy it.

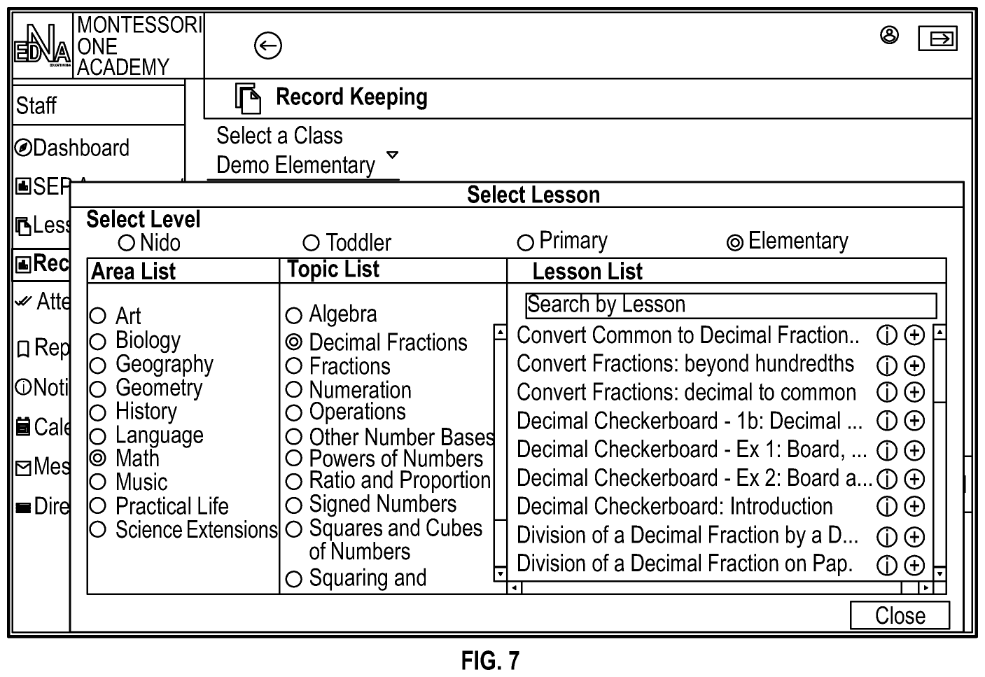

In electing to re-present the lesson, the teacher can be presented with a data entry field so that the teacher can insert a comment to document the reason that the lesson is being re-presented. Optionally, the information about the lesson including, for example, the lesson title, can be pre-loaded for the teacher. The record keeping system can be organized by subject and lesson. For example, as illustrated in FIG. 7, the teacher can select math, and then the topic list can be populated with math topics, and upon selecting “decimal fractions,” the lesson list can be populated with each lesson that is directed to decimals and/or fractions. The teacher can then select the appropriate lesson or can click on an information icon to be presented with information about the lesson.

### Lesson Planning

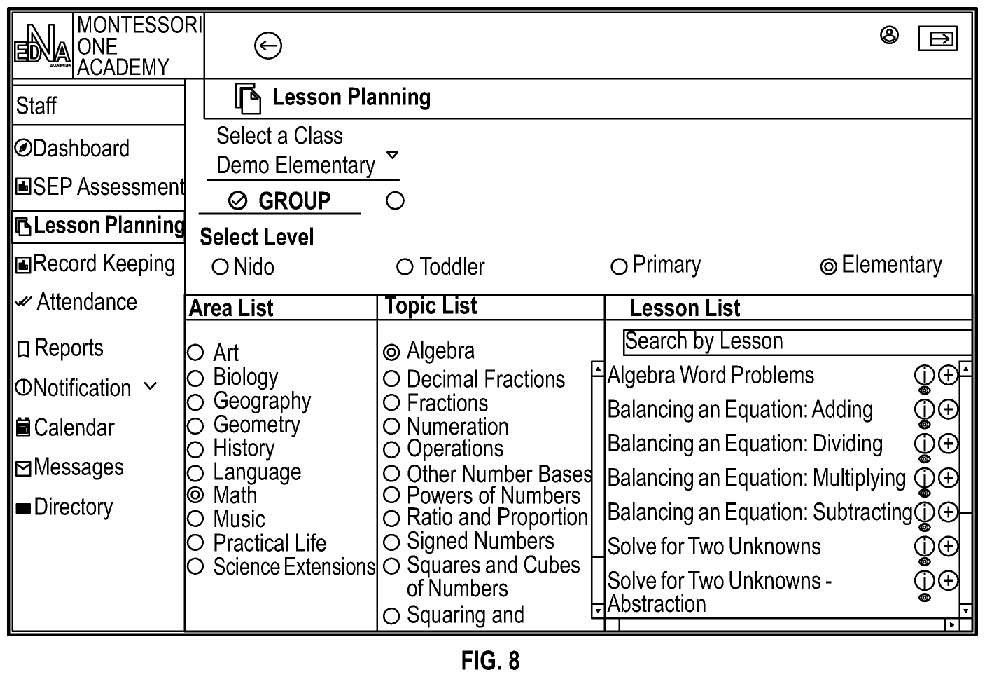

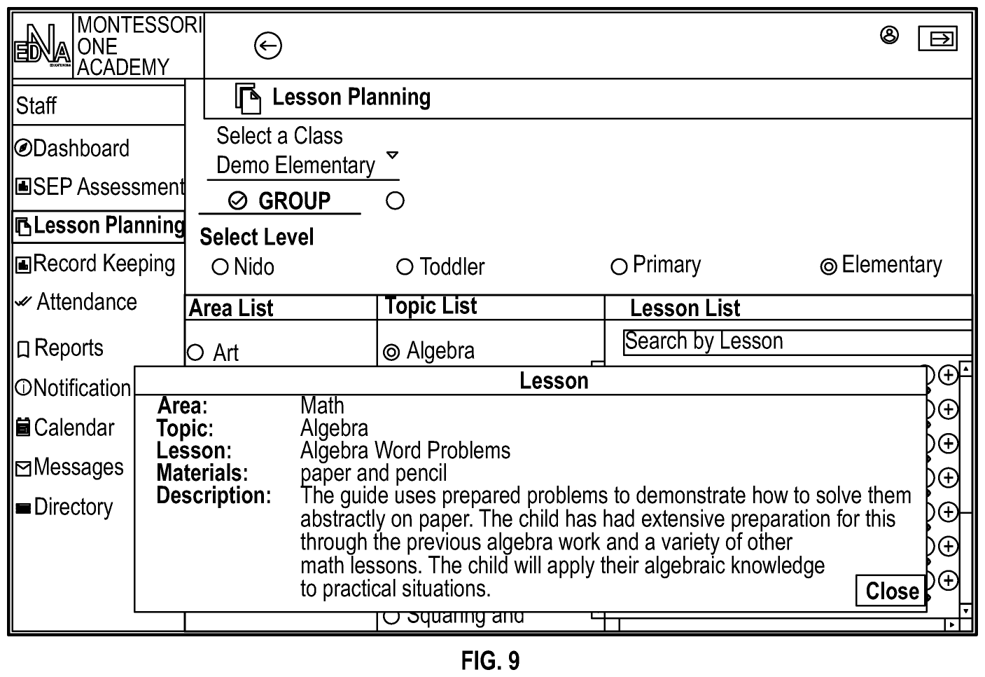

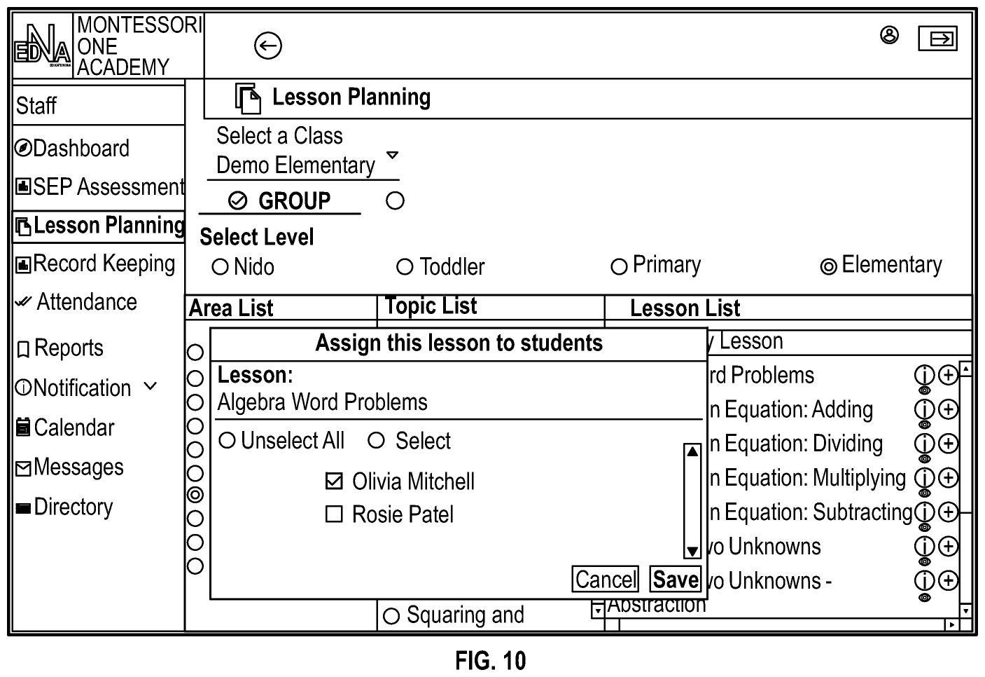

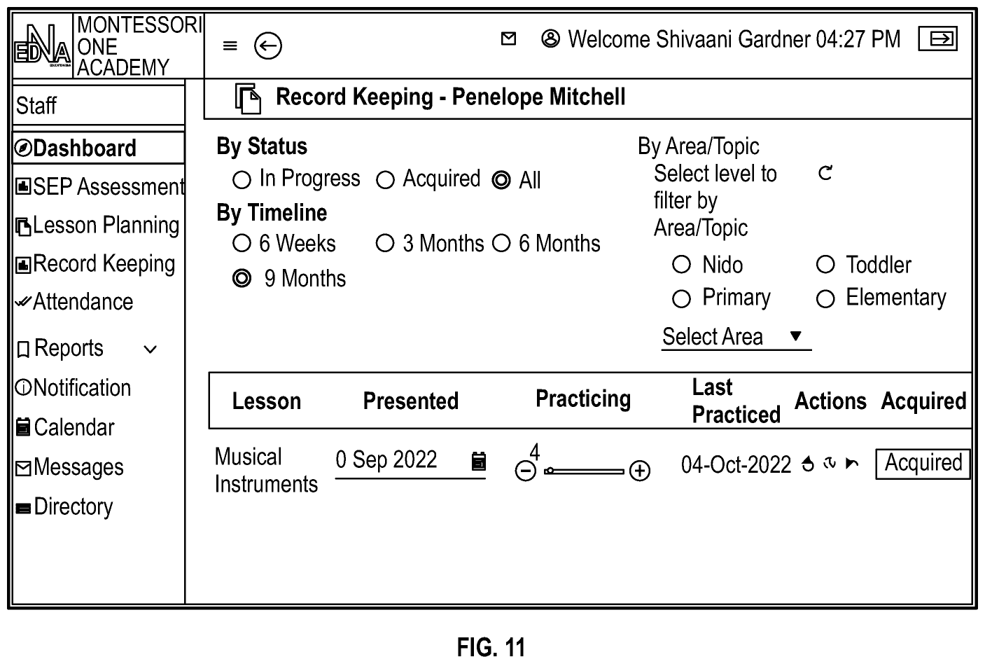

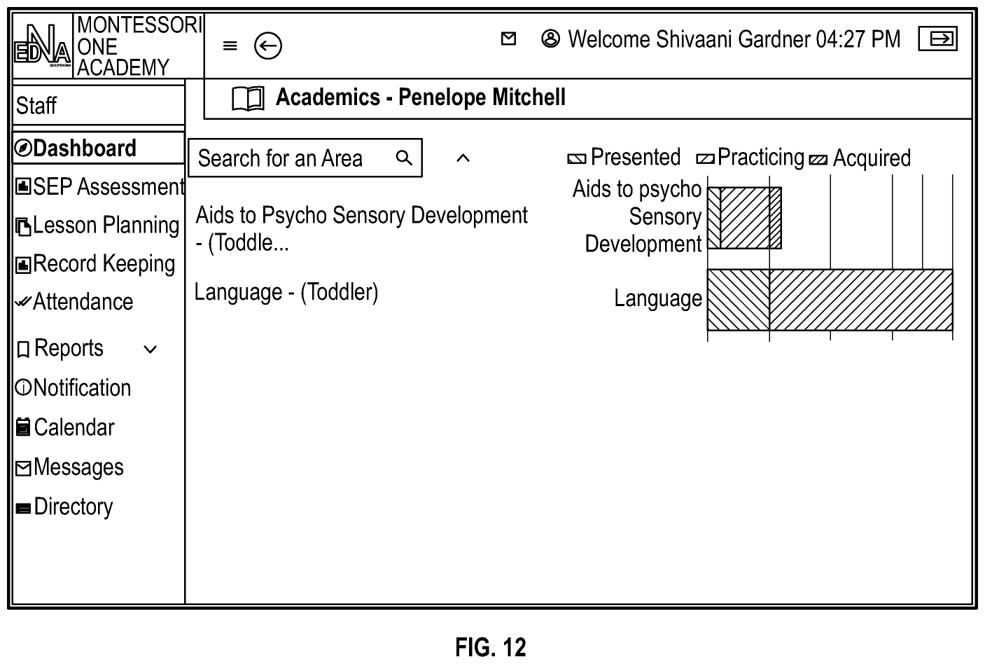

As illustrated in FIG. 8, within the lesson planning portion of the program, the teacher can select a class (for example, the teacher's first hour class of students or the teacher's second hour class of students), and the students and assignments will be populated. In the lesson planning module, the teacher is able to customize the curriculum and meet each child where he or she is at developmentally. The teacher can optionally click on an icon next to each lesson to be presented with a description of the lesson (see FIG. 9). As illustrated in FIG. 10, the teacher can then quickly and easily choose a lesson and take an action to assign it to students—for example, by clicking on a box next to each student's name. If the teacher wishes to check on or update the status of a student's progress, the teacher can choose an overview of information for any given student (FIG. 11). In addition, the teacher can easily see which students in a class are working on the same material and which students have acquired it. This enables the teacher to encourage or arrange for students, who are working on the same material, to work together and/or for a student, who has acquired the concept, to help and/or guide the other students. As illustrated in FIG. 12, within the dashboard, the teacher can elect to display an academic summary for any individual student. By doing this, the teacher can be presented with a graphical representation which summarizes the status of the student's progress for each assigned lesson. For example, the teacher can be presented with a chart for each lesson that shows an illustrative representation of the presentation and practice sessions of a lesson and whether the student has acquired the lesson. The ability to see the number of times a student practices a lesson before acquiring it and comparing this to other lessons in other subject areas can indicate where a child's academic strengths and weaknesses lie.

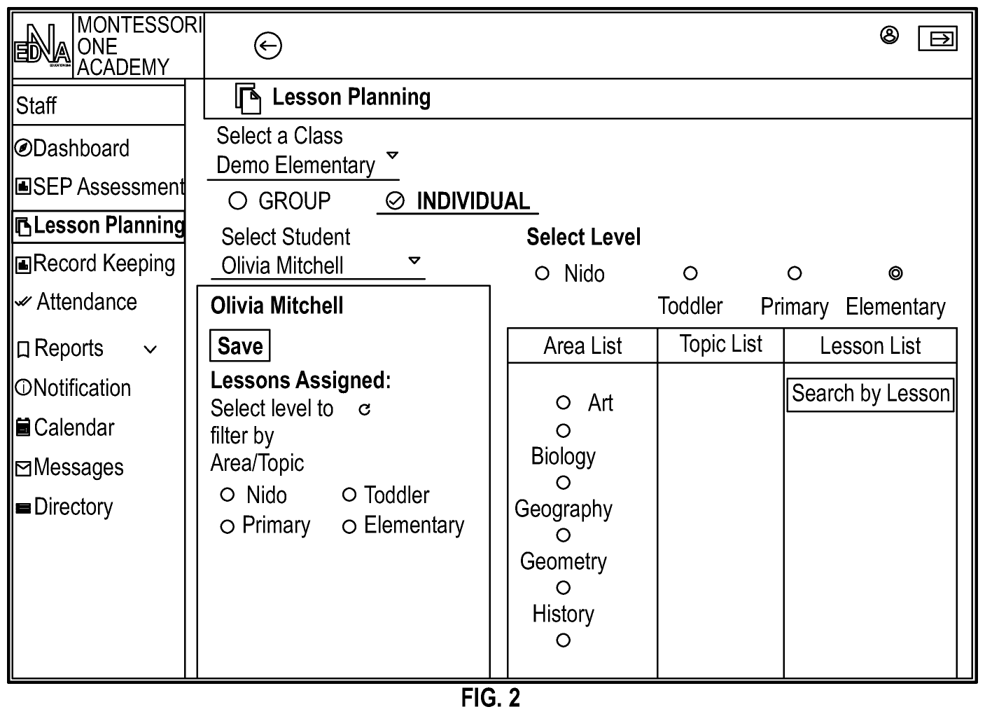

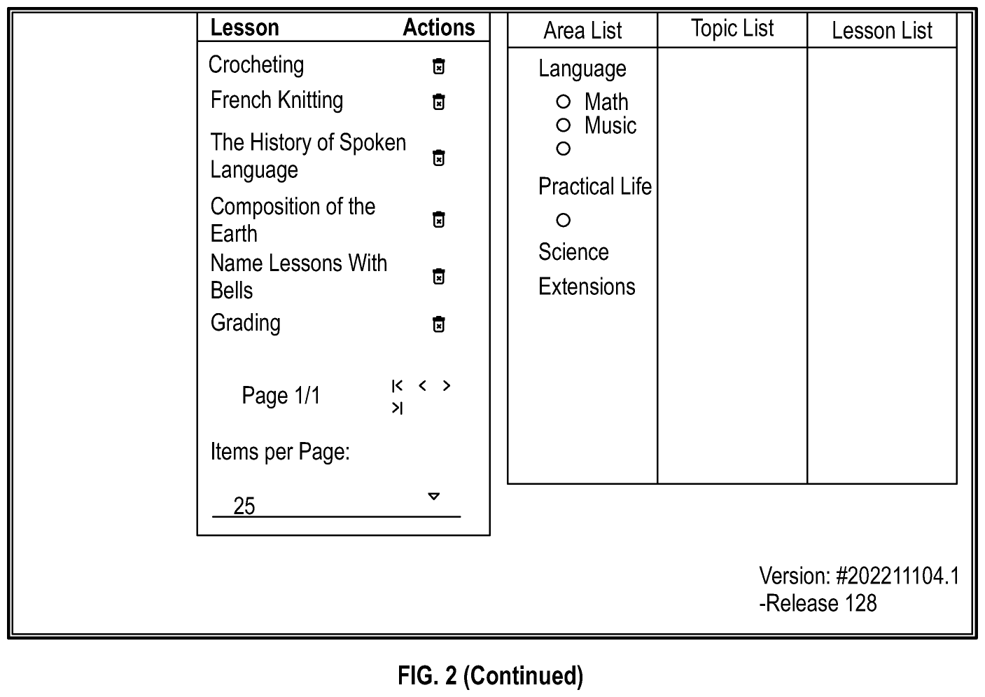

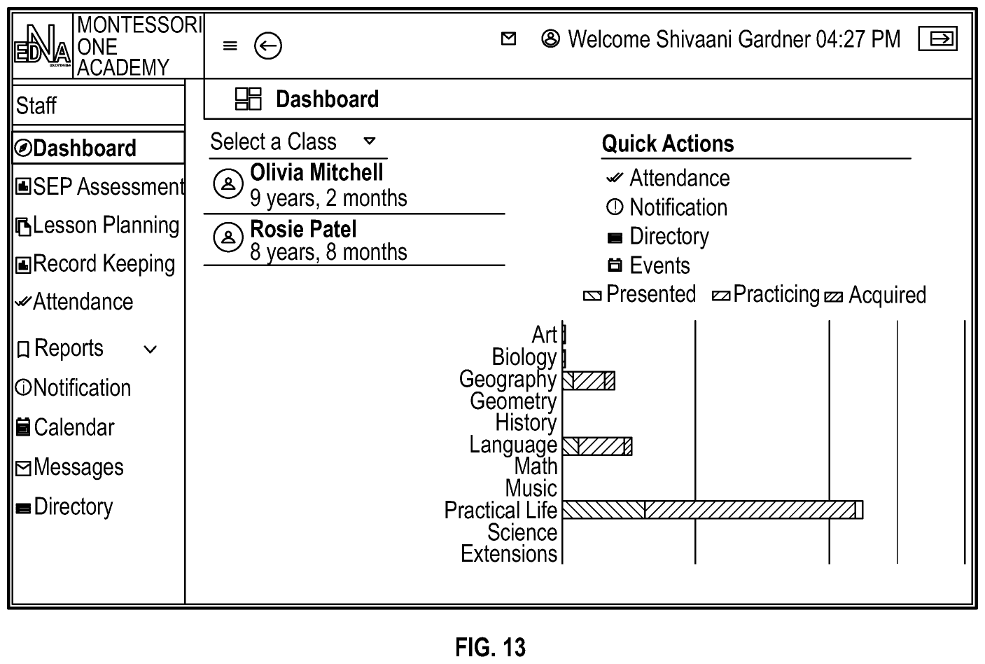

As illustrated in FIG. 2, in the lesson planning interface, the teacher can select individual students from any class that the teacher has and can be presented with an interface of assigned lessons which can be sorted by subject. Optionally, instead of displaying the dashboard information for a single student, the teacher can elect to display a dashboard which summarizes the data for an entire class, as illustrated in FIG. 13. Embodiments of the present invention can also provide a teacher an evaluation dashboard which can show the overall progress of the class and or otherwise summarize data about the students for a class. This can enable the teacher to identify lessons which all of the students seem to struggle with or lessons which students acquired quickly.

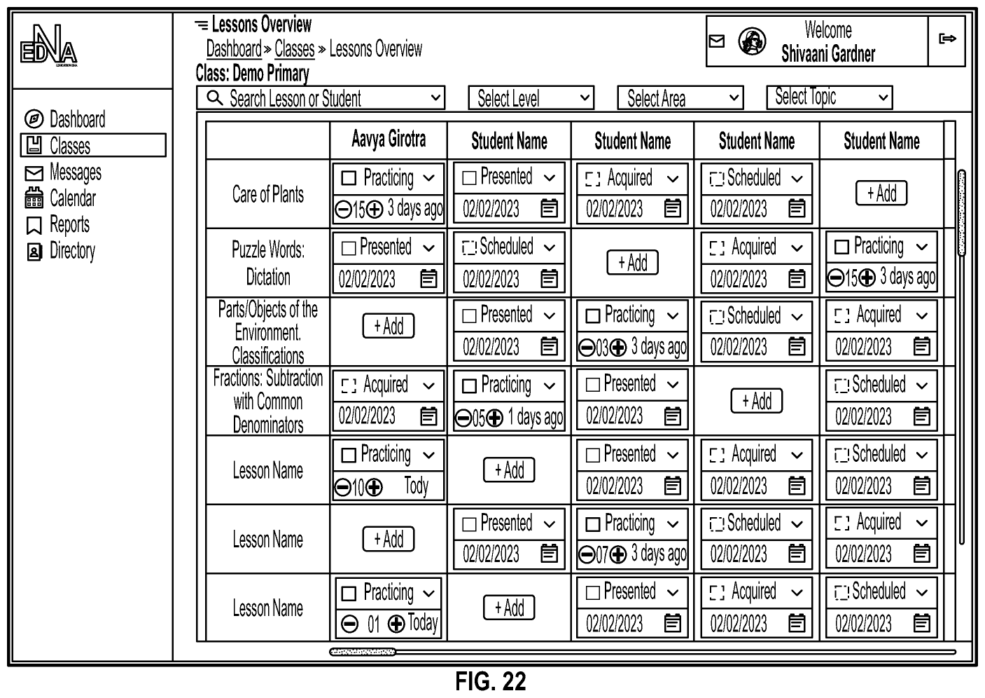

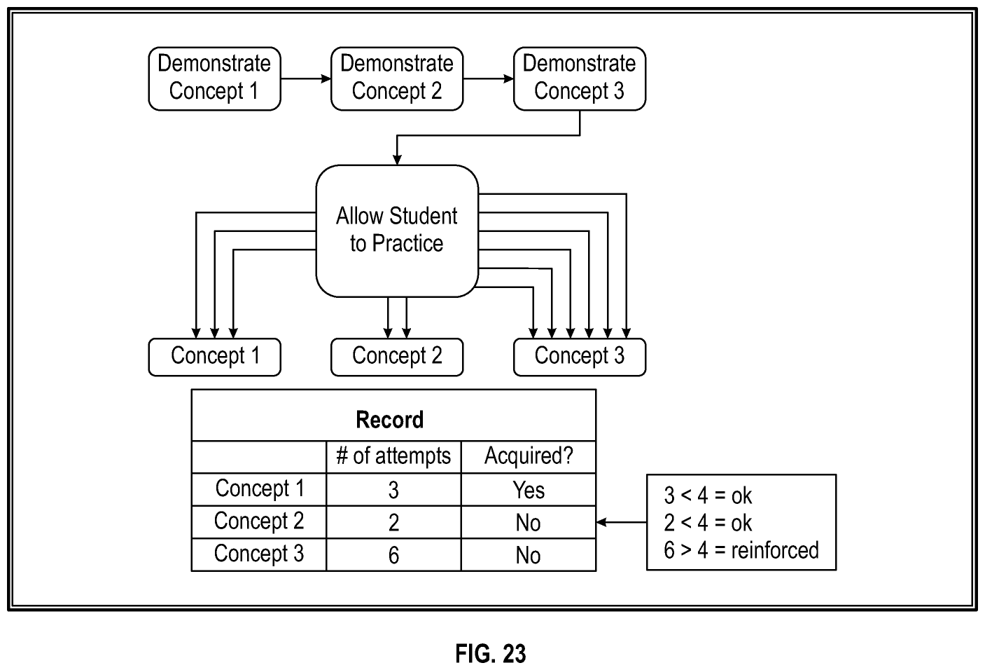

In one embodiment, as illustrated in FIG. 22, a lessons overview can be provided wherein data regarding each student from an entire class can be provided on a single display. This makes it easy for a teacher or administrator to quickly and easily see the status of every lesson of every student in a class. In one embodiment, the software can cause the computer to display whether the student is practicing or has acquired the lesson. And, if the lesson has not yet been assigned to the student, the teacher can optionally easily do so simply by performing an action, for example by clicking on an “add” button for that assignment in that student's lessons list. In addition, the display can show the date that the lesson was assigned and/or was acquired by the student. In addition, the display can show how many times the student has practiced the lesson and can optionally display the date that the lesson was last practiced or the amount of time that has passed since the student last practiced the lesson (for example, to show that student Aavya Girotra has practiced the “Care of Plants” lesson 15 times and that the last time that Aavya practiced that lesson was 3 days ago). It also highlights the number of practices that the student has performed on a lesson. Optionally, when a predetermined number of practices has been reached (for example, 15) an alert or other indicia can be provided to notify the teacher that the number has been reached or surpassed without the student having acquired the lesson. This preferably also enables teachers to indicate that a lesson has been re-presented and the program preferably continues tracking the number of practices after re-presentation.

Most preferably, the teacher evaluation dashboard allows the teacher to select individual students to open that student's record. This can enable a teacher to monitor the progress of an entire class for one or more, or all, subjects. By having this summarized view, the teacher can gauge the effectiveness of his or her teaching for each lesson. For example, if a teacher sees that a significant number of students have practiced a lesson numerous times and has not acquired the concept, this may inform the teacher that this concept was not presented as clearly as possible, and the teacher may thus choose to re-present the lesson.

As further illustrated in FIG. 13 within the dashboard, the teacher can be presented with a list of quick actions that he or she can take, which can include displaying the attendance for a class, displaying notifications for a class, displaying a directory of contact information for the class and/or parents of the class, and displaying events that have been calendared for that class.

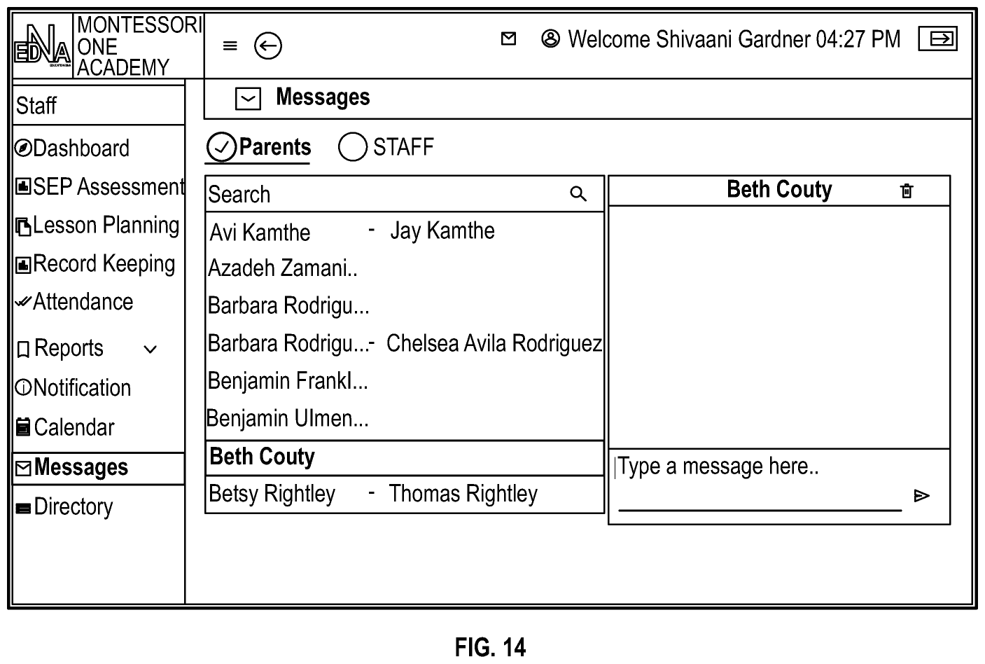

As illustrated in FIG. 14, from the teacher portal, the teacher can push out notifications to the parents of individual students or to all of the parents of a class of students—for example, to tell a student's parents about an incident that was caused by the student at school today or to alert all parents about an upcoming event or class project. In one embodiment, the parents can download an application onto their smartphones which can be used to sign in and out daily, to update information about who is allowed to pick up the student and to access their student's record and/or to review upcoming assignments or to learn about what is being covered in class and/or to read any notifications from the teacher. Optionally, such notifications can be push notifications which alert the parent when a new message or other alert is issued. In one embodiment, notifications can be sent via an email to the parents.

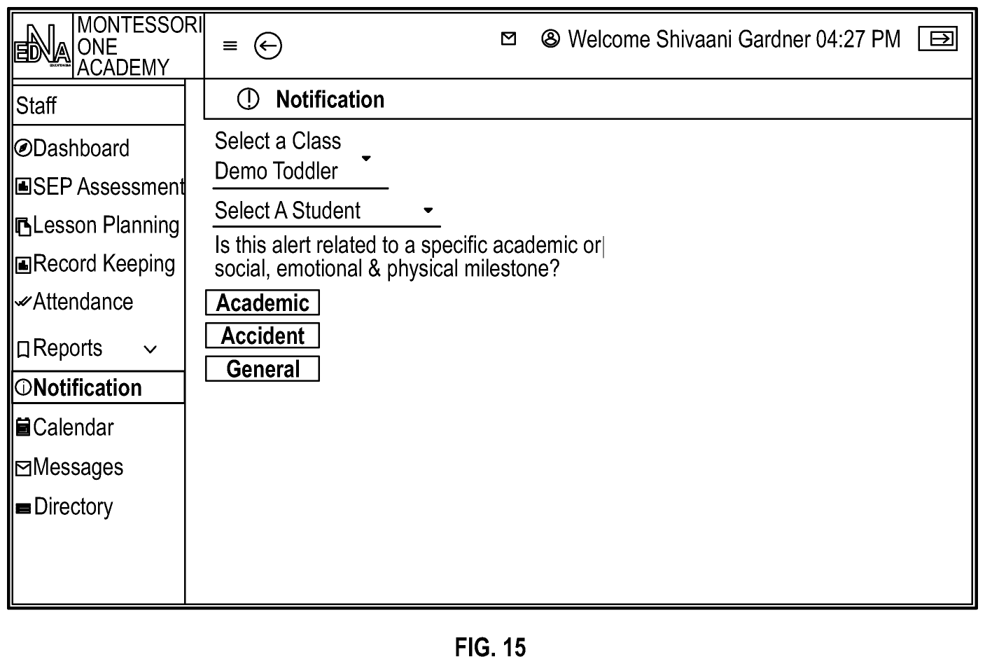

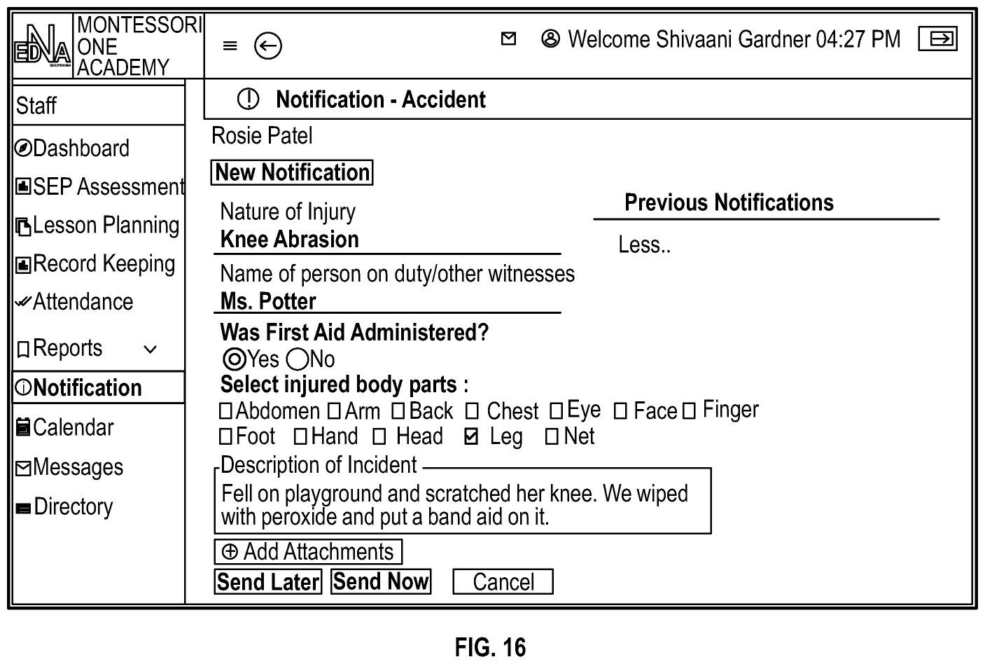

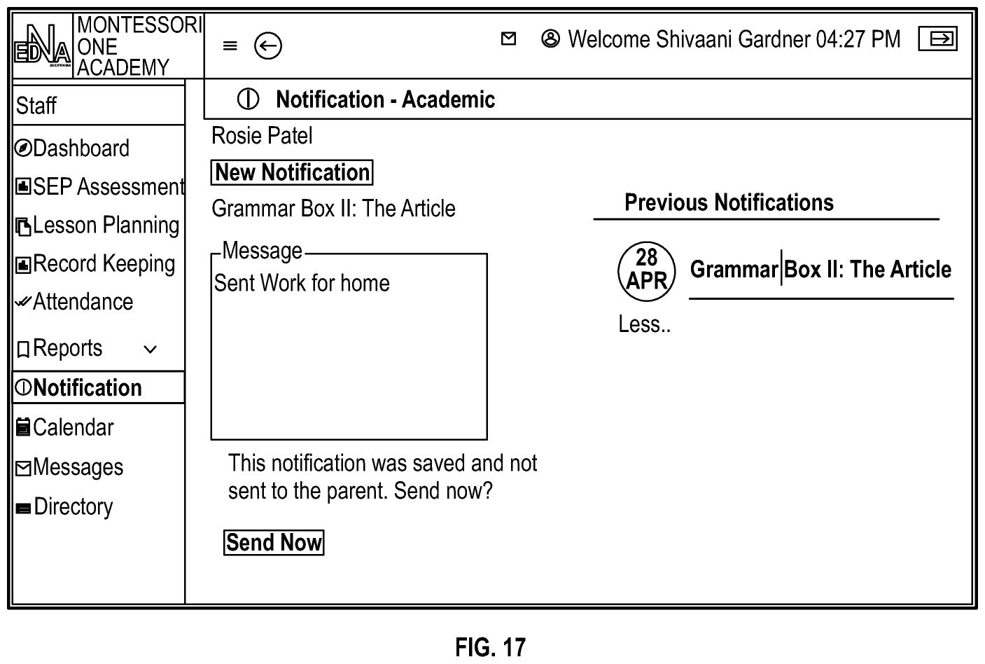

As best illustrated in FIG. 15, a notifications tab can be provided. Once selected by a teacher or administrator, the teacher can select from a list of his or her classes and can then select a student and the type of notification that is to be sent. As illustrated in FIG. 16, the type of notification that the teacher selects can be loaded with predetermined fields that are relevant to that type of notification. For example, when selecting an “accident” notification, a “nature of injury” field can be provided and a field for any witnesses can be provided as well as a list of major body parts so that the teacher can quickly and easily report the injury to the parents and/or administrators. The notification can provide the ability for the teacher to attach a file, which can be, for example, a photograph of the injury. Optionally, the notification can be stored, preferably automatically, and associated with the student so that a log of notifications can later be accessed (see FIG. 17, for example, which notes a previous notification that was created for student Rosie Patel—it indicates the date the previous notification was created and the subject of the previous notification). In that particular example, the previous notification was an academic notification, and although it was created, the note indicates that the teacher did not previously send the notification. Thus, the teacher is asked if he or she wishes to send the notification now. Other previous notifications, including notifications that were previously sent, can be stored and noted in the “previous notifications” log.

In one embodiment, the record keeping can be accessed via a website by a parent, teacher, or student logging into the website. For embodiments wherein the record keeping can be accessed by a parent, a parent portal can be provided such that data related to a student of the parent and/or related to progress and/or status of educational milestones of the student can be presented to the parent. In one embodiment, in the teacher portal, each student can have a “note” field where the teacher can make notes to himself or herself about the student. Optionally, these notes can be hidden from view of the parent or student. This enables the teacher to remind himself or herself that he or she needs to work to help the student with a particular lesson.

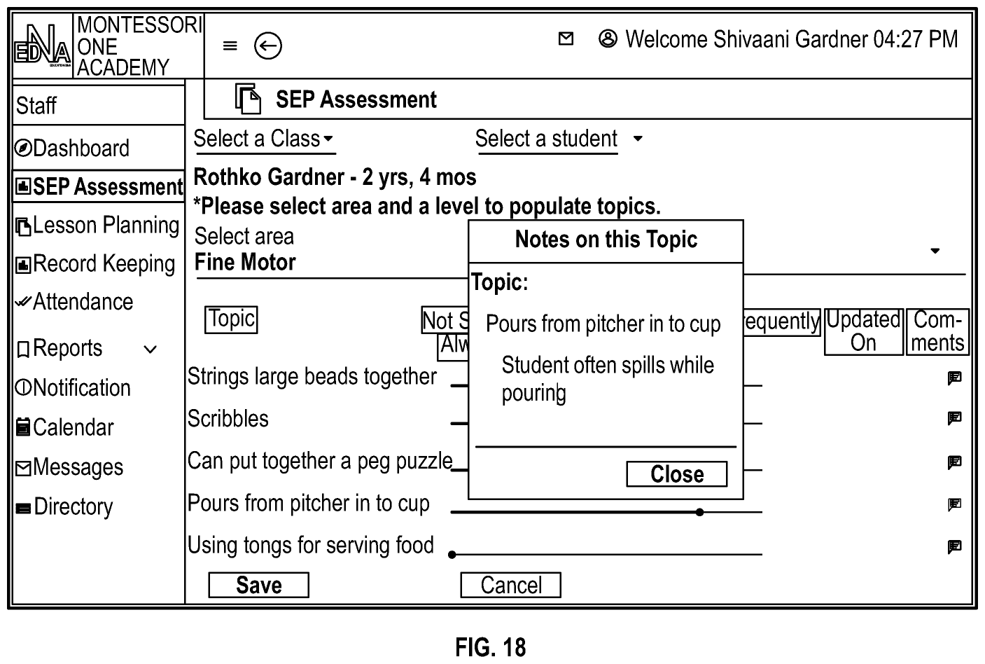

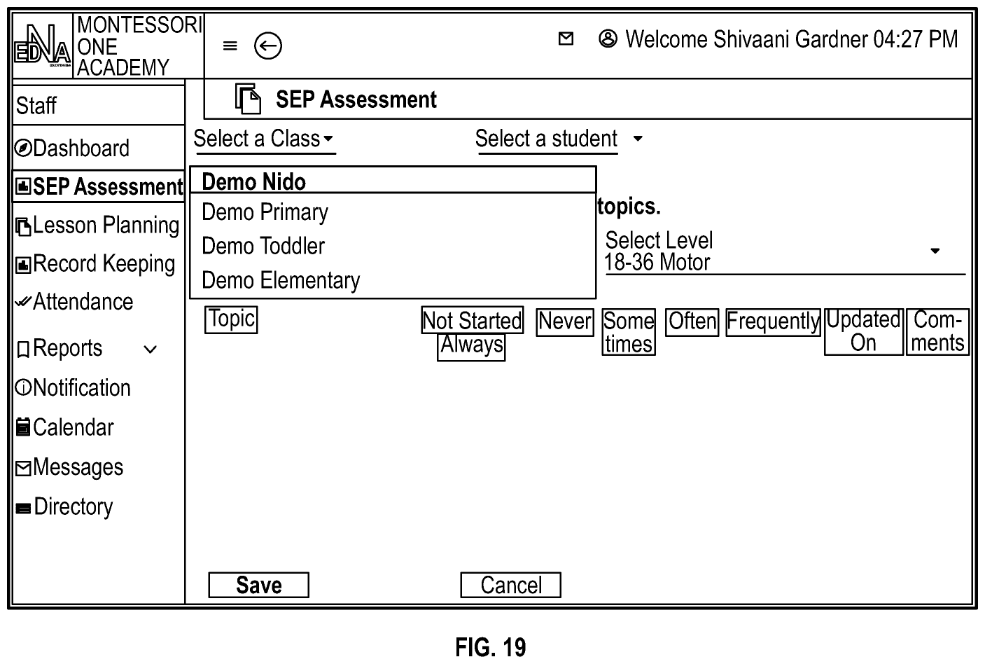

Optionally, the ability to enter a note about a student can also be provided in a social, emotional, and/or physical (“SEP”) assessment portion of the program. For example, as illustrated in FIG. 18, the teacher can enter a note about a student—for example, that the toddler often spills while pouring. Within the SEP assessment, the teacher can select a class (FIG. 19).

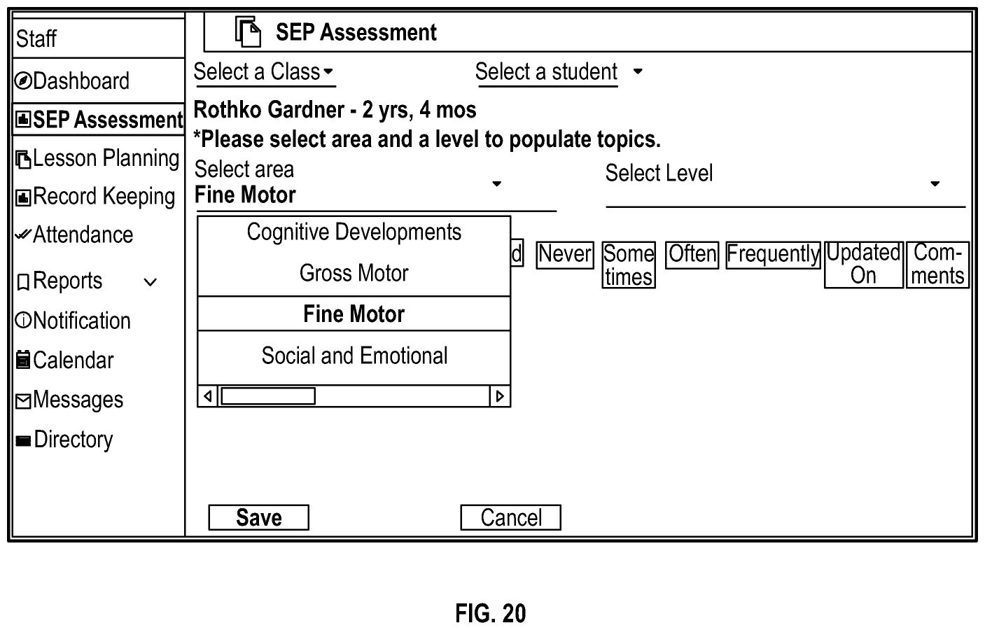

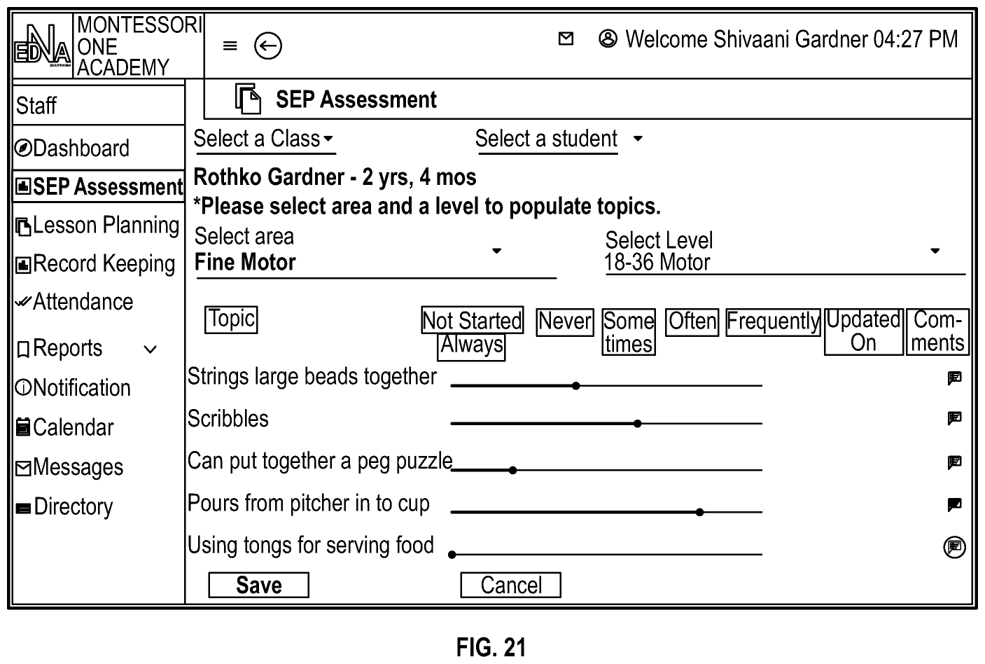

As illustrated in FIG. 20, the teacher can then select a student from the class and can enter SEP information about any of various aspects of developmental milestones for a student of that age range. For example, a student who is 2 years and 4 months old can have a profile that is pre-populated with various cognitive development milestones, gross motor skills milestones, fine motor skills milestones and social and emotional milestones. As illustrated in FIG. 21, the teacher can update the SEP assessments for milestones for the student by simply clicking next to each milestone to indicate how often the student performs the milestone. The milestones that are automatically loaded based on the students age can include those which were previously disclosed in this application in the various tables and lists.

### Student Portfolio

By continuously keeping a record of the progress of the student, a student portfolio can thus be created. Preferably, the portfolio follows the student throughout their educational career and even between schools, ideally representing their entire educational profile or at least a significant part of their education. In one embodiment, this is accomplished by including all of the data associated with the student in a single file, or multiple related or associated files, that can be transferred between educational schools/institutions and/or classes or divisions within an educational school/institution.

Optionally, the student portfolio can provide the ability for a student to add to their portfolio. For example, if the student is in high school and enjoys painting, the student can upload pictures of their artwork and any notes that they would like to include about it or about their interest in art. If a student is into sports, the student can upload information about any medals or awards that he or she has achieved or to otherwise provide more information about the types of sports that the student is likes. Likewise, the parents of a student can optionally have the ability to add additional information about the student including information about sports or other activities of interest to them. And, parents can optionally upload videos, photos, or other documentation about this. The ability for students and/or parents to add this additional information provides the ability for the student's portfolio to be much more robust and personalized, thus giving better insight into the type of person the student truly is.

The student's portfolio can then be used by universities and/or employers when screening candidates. Optionally, a university can search a database of student portfolios to find candidates that meet some predetermined criteria they are looking for. For example, a student can upload their college application and link to or include a copy of their portfolio. Or, if students agree to the public release of all or a portion of their portfolio, universities and/or companies can search a database of all available portfolios to find students who meet predetermined criteria in an attempt to then recruit the student to their university or place of employment.

In one embodiment the portfolio can include a short video and/or slide presentation, which the student can create and upload that introduces the student to a university or potential employer or which otherwise provides more insight about the student. In one embodiment, when a student reaches a predetermined age or other milestone, the student can elect to remove or hide parts of their portfolio or records that have been entered by teachers. For example, upon graduating from high school or upon reaching the age of 18 the student can elect to hide information about grades attendance from when he or she was in elementary school.

In one embodiment, the parents can choose to share their phone number or other contact information with other parents—for example, they can choose to share their contact information with all other parents of students in their child's class or in the school. This can make it easier for parents to interact with other parents and to schedule playdates.

In one embodiment the system of the present invention can prompt a user to log in as either a teacher and administrator or a parent. Assuming that the person has the proper credentials for logging in, the person will be presented with different options depending on the type of user they have logged in as.

Optionally, embodiments of the present invention can include a general or specific purpose computer or distributed system programmed with computer software implementing steps described above, which computer software may be in any appropriate computer language, including but not limited to C, C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

The terms, “a”, “an”, “the”, and “said” mean “one or more” unless context explicitly dictates otherwise. Note that in the specification and claims, “about”, “approximately”, and/or “substantially” means within twenty percent (20%) of the amount, value, or condition given. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A method for providing educational development of a student, the method comprising:
demonstrating a plurality of educational concepts to the student;
allowing the student to choose to perform any one or more of the plurality of educational concepts;
maintaining indicia of interaction of the student with respect to each of the plurality of educational concepts, the indicia of interaction comprising:
a first field comprising a first record representing a number of attempts by the student performing each respective one of the plurality of educational concepts; and
a second field comprising a second record of whether the student has acquired each respective one of the plurality of educational concepts;
observing the student performing the chosen one or more of the plurality of educational concepts;
evaluating whether the student has acquired at least one of the plurality of educational concepts;
updating the first record of the first field for each respective educational concept to indicate the number of times the student was observed to perform the respective educational concept;
comparing the first record of the first field to a predetermined value; and
providing reinforcing education to the student for each of the plurality of educational concepts for which the first record of the respective first field meets or exceeds the predetermined value.

2. The method of claim 1, wherein the predetermined number is different for at least two of the plurality of educational concepts.

3. The method of claim 1, further comprising updating the second record of the second field to indicate competency when the results of the evaluation step result in a finding of competency.

4. The method of claim 3, further comprising presenting a new educational concept to the student after a finding of competency for at least one of the plurality of educational concepts.

5. The method of claim 4, wherein maintaining indicia of interaction comprises maintaining a database file.

6. The method of claim 1, wherein the predetermined value comprises a whole number.

7. The method of claim 1, wherein providing reinforcing education to the student comprises demonstrating each of the plurality of educational concepts for which the first record of the respective first field meets or exceeds the predetermined value.

8. The method of claim 1, further comprising a third field comprising a third record representing results of observed social or emotional condition or observed social or emotional progress of the student, selected from the group consisting of: self-control, social maturity, cooperativeness, assuming responsibility for actions, self-confidence, acceptance of guidance, working well with others, dependability, self-motivation, adaptability, responding well to challenges, identifying feelings, and expressing feelings.

9. The method of claim 1, further comprising a third field comprising a fourth record representing results of an observed physical condition or physical progress of the student, selected from the group consisting of lifts head, smiles, turning to face stimulus, sits up with support, sits up without support, laughing, crawling, pulling up to standing position, walks with support, walks without support, places objects into container, feeds self, walks backwards, kicks a ball, eats independently, throws an object, stacks objects, drinks from a cup, and scribbles.

10. The method of claim 1, wherein the educational concepts comprise physical educational concepts.

11. The method of claim 1, wherein the educational concepts comprise academic educational concepts.

12. The method of claim 1, wherein the educational concepts comprise hands-on Montessori works.

13. The method of claim 1, wherein at least a portion of the method is performed by a computer processor operating on instructions that are stored in non-tangible computer readable media.

14. The method of claim 13, wherein the processor updates the indicia of interaction of the student.

15. The method of claim 13, wherein the processor compares the first record of the first field to the predetermined value.

16. The method of claim 13 further comprising providing a parent portal and wherein educational progress of a parent's respective student can be displayed on a user interface.

17. The method of claim 16 wherein information regarding educational concepts are displayed on the user interface.

18. The method of claim 13 wherein milestones and other information relating to the student can be input into a profile of the student by the student and/or by a parent of the student.

19. The method of claim 18 wherein the profile of the student also includes information relating to educational developmental milestones which are entered by an instructor.

20. The method of claim 19 wherein the profile of the student is successively added to year after year throughout a period of years of a childhood of the student and wherein the profile comprises a selectable field associated with a plurality of items of information such that the student and/or the student's parent can select at least some of the items of information from the first record and/or the second record and wherein the selected items can be extracted and shared electronically with secondary schools and/or employers.

21. The method of claim 1 wherein the step of maintaining indicia of interaction of the student is performed by a first instructor of an organization and wherein a second instructor of the organization reviews at least some of the maintained indicia to determine an appropriate course of instruction for the student such that the second instructor can begin working with the student at or near a level where the first instructor stopped.

22. The method of claim 1 wherein evaluating whether the student has acquired at least one of the plurality of educational concepts comprises recording indicia of acquisition of an acquired educational concept.

23. The method of claim 22 further comprising monitoring the student while the student teaches the acquired educational concept to a second student who has not acquired the educational concept.

24. The method of claim 23 further comprising reevaluating whether the student has acquired the acquired educational concept based on the results of the monitoring.

25. The method of claim 1 further comprising identifying a subject of interest to the student based at least in part on information contained in the first field and/or the second field.

26. The method of claim 25 further comprising challenging the student with one or more further educational concepts in the identified subject of interest.
